(19) United States
(12) Patent Application Publication
(10) Pub. No.: US 2026/0210330 A1
(43) Pub. Date: Jul. 23, 2026

(54) ELECTRIC GENERATING ASSEMBLIES

(71) Applicants: David M. Byler, Blanchard, MI (US); David L. McLellan, Remus, MI (US)

(72) Inventors: David M. Byler, Blanchard, MI (US); David L. McLellan, Remus, MI (US)

(21) Appl. No.: 19/428,531

(22) Filed: Dec. 22, 2025

Related U.S. Application Data
(63) Continuation-in-part of application No. 18/595,815, filed on Mar. 5, 2024.

(51) Int. Cl. F03D 9/32; F03D 1/04; F03D 9/11; H02K 7/18

(52) U.S. Cl. CPC F03D 9/32; F03D 1/04; F03D 9/11; H02K 7/183; F05B 2240/94; F05B 2260/40

(57) ABSTRACT

Electric generating assemblies wherein such assemblies are intended to be mounted on a vehicle, such that a front of a hollow funnel is directed to the front of the vehicle. As the vehicle moves forward, the funnel picks up wind which is passed through the funnel and turns a fan which contains vanes that have leading edges wherein the leading edges are one inch or greater distance from the inside wall of the funnel, which generates electricity.

### TO WHOM IT MAY CONCERN

Be it known that we, David M. Byler, a resident of the city of Blanchard, County of Isabella, State of Michigan and David L. McLellan, a resident of the City of Remus, County of Isabella, State of Michigan, both United States of America citizens have invented new and novel

### ELECTRIC GENERATING ASSEMBLIES

which this is a specification therefor.

### CROSS-REFERENCE TO RELATED APPLICATIONS

This application claims priority benefit to U.S. patent application number Ser. No. 18/595,815 filed Mar. 5, 2024.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Around the turn of the last century and up until the 1970's electrical generation using wind was practiced. The devices utilized then were often windmill type of devices and were intended to capture the wind to supply small amounts of electrical power.

With the advent of electrically powered automobiles and the like, it has become advantageous to utilize large arrays of batteries to supply electrical energy for them.

The instant invention is an attempt to move away from the problems associated with large arrays of batteries and their problems such as fires, extra heavy weight loads on the vehicles, short term driving distances, failure to charge when cold, and the like.

In a search carried out by the patentees herein, there was discovered a piece of prior art pertaining to vehicle-wind generated electrical energy, namely, U.S. Pat. No. 9,643,729 that issued May 9, 2017, to Walter-Robinson, that deals with an energy cell regenerative system for electrically powered aircraft in which the wind force generated by the propeller of an aircraft is used to drive an energy system. A second reference, U.S. Pat. No. 11,746,751 to Oroza, deals with airflow power generating apparatii. The devices of this invention have been proven to be inefficient

### BRIEF SUMMARY OF THE INVENTION

This invention in one embodiment deals with an electric generating assembly. The assembly comprises an air collection funnel, wherein the funnel has a front end opening and a back end opening. The front end opening is larger in size than the back end opening.

There is a fan, the fan having a plurality of vertical vanes. The fan is mounted in a predetermined position in the funnel such that a portion of any air moving through the funnel contacts the vanes, the leading edge of said vanes is at least one inch from the inside wall distant from said funnel, a portion of any air moving through the funnel contacts said vanes and a portion of the air moving through the funnel passes the vanes;

The fan is mounted on a shaft, and the shaft extends below said funnel a predetermined distance. The shaft has a terminal end and there is an alternator mounted on the terminal end. The alternator is electrically attached to a voltage regulator by electrical wires.

In a second embodiment, there is an electric generating assembly comprising an air collection funnel. The funnel has a front end opening and a back end opening. The front end opening is larger in size than the back end opening.

There is a fan. The fan has vertical vanes. The fan is mounted in a predetermined position in the funnel such that a portion of any air moving through the funnel contacts the vanes and a portion of the air passing through passes the vanes.

The fan is mounted on a first shaft and the first shaft extends below the funnel a predetermined distance. The first shaft has a terminal end and a first driving means mounted on the terminal end.

There is an alternator mounted securely separately from the first shaft. The alternator has an extended center shaft, and the extended center shaft has a second driving means mounted on a terminal end and the first driving means and the second driving means are horizontally aligned. There is a drive belt or chain connecting the first driving means and the second driving means.

There is a voltage regulator electrically attached to the alternator by electrical wires.

### BRIEF DESCRIPTION OF THE SEVERAL VIEWS OF THE DRAWING(S)

FIG. 1 is a full side view of the first embodiment of this invention.

FIG. 2 is a full top view of the device of FIG. 1.

FIG. 3 is a full side view of a second embodiment of this invention.

FIG. 4 is a full side view of the device of FIG. 3 with a battery attached.

FIG. 5 is an illustration of a drive means which is a chain and sprocket arrangement.

### DETAILED DESCRIPTION OF THE INVENTION

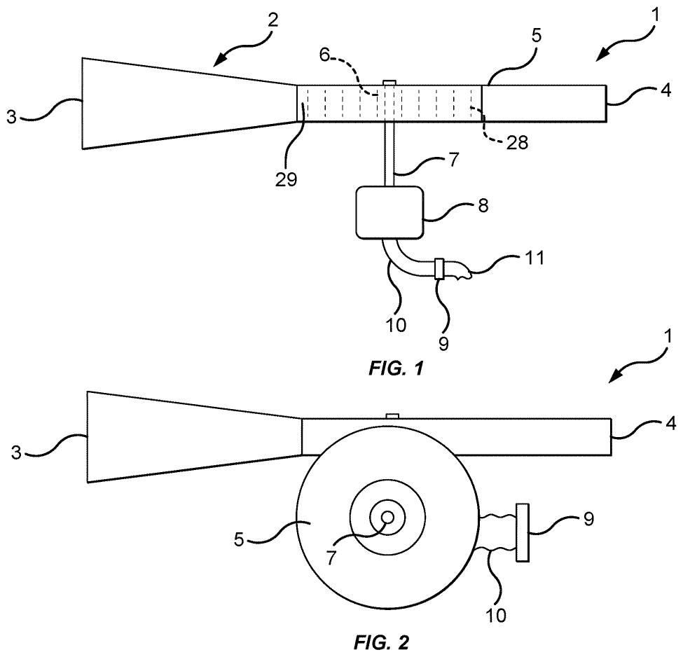

What is disclosed and claimed herein are electric generating assemblies. FIG. 1 shows a full side view of one embodiment of an electric generating assembly 1 of this invention.

Such assemblies are intended to be mounted on a vehicle, such that the front of a hollow funnel is directed to the front of the vehicle. As the vehicle moves forward, the funnel picks up wind which is passed through the funnel and turns a fan which generates electricity.

Thus, in FIG. 1, there is shown an elongated hollow funnel 2, that has a front end 3 and a back end 4 wherein the front end 3 opening is larger in area than the back end 4 opening. This configuration allows air to move through the funnel and as the wind arrives at a narrower part of the funnel 2, the pressure increases. It is at this point and all the way to the back end, that one can insert a fan 5. The fan 5 is included in the funnel 2 as is shown in FIG. 2 or it can be located in only a portion of the funnel 2 (FIG. 2). The configuration of the funnel 2 is not essential, it can be round, elongated either horizontally or vertically, square, triangular, and the like, without affecting the purpose of the invention.

The funnel 2 is mounted such that it is essentially horizontal. The funnel 2 has vertical vanes 6 which catch the wind as it passes through the funnel 2. The funnel 2 can have a length of 1 foot to 6 feet. The leading edges 28 of the vanes are required to be at least one inch from the interior wall of the funnel (see FIG. 1) to open a gap 29 between the leading edges 28 and the interior wall of the funnel.

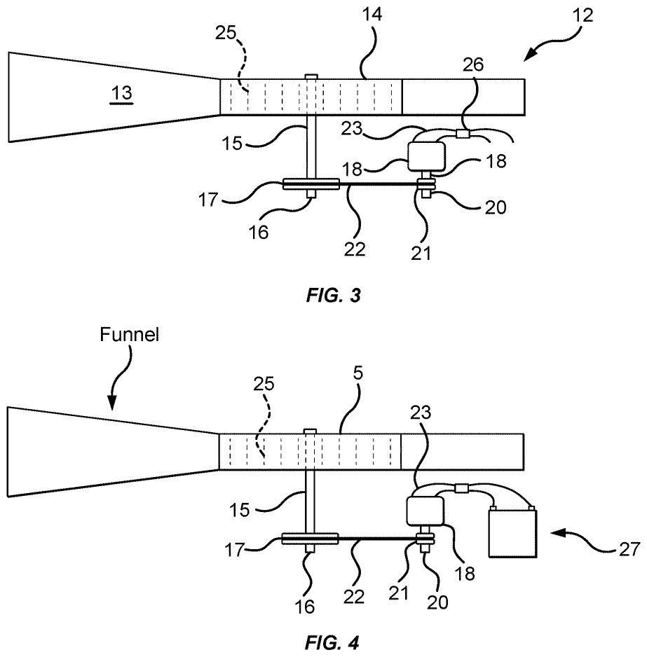

The fan 5 has a center shaft 7 which extends below the actual fan 5 to accommodate and hold an alternator 8. The alternator is electrically attached to a voltage regulator 9 by electrical wires 10. Ultimately, the electrical wires 11 are attached to a battery (FIG. 3). The battery is not part of this device.

As the vehicle moves forward, the wind passes through the funnel 2 driving the fan 5, which drives the shaft 7 which drives the alternator 8 to generate electricity. The voltage regulator 9 governs the amount of voltage fed to the battery. It is estimated that this assembly will generate approximately 14 to 18 volts of electricity if the vehicle is going 50 miles/hour.

FIG. 2 is a full top view of the device of FIG. 1, showing only a portion of the fan 5 inserted in the funnel 2.

Turing now to another embodiment of the invention, there is shown in FIG. 3 an electric generator assembly 12. This assembly 12 comprises a funnel 13, a fan 14 with vertical vanes 25, with a vertical shaft 15 centered in the fan 14. The vertical shaft 15 extends below the fan 14 and it has a terminus end 16. The terminus 16 has a first drive means 17 (belt and pulleys) mounted on it.

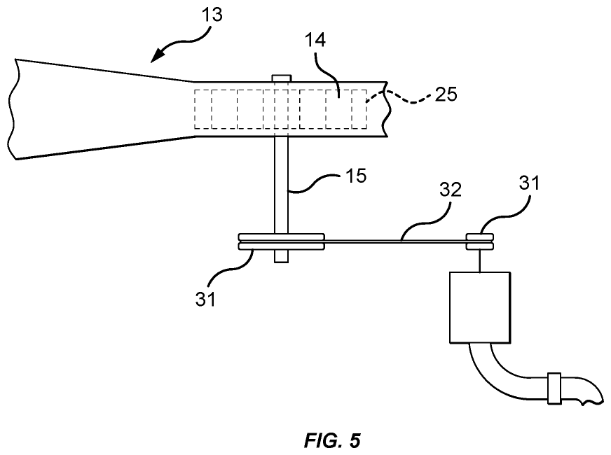

There is an alternator 18 that is mounted near the funnel 13 such that it is rigidly mounted. The alternator 18 has a center shaft 19 and this shaft 19 has a terminal end 20. There is a second drive means 21 mounted on the terminal end 20 and this drive means 21 is horizontally aligned with drive means 17. There is a drive belt or chain 22 (see FIG. 5) mounted on the two drive means 9 (i.e. pulleys or sprockets). There are first lead wires 23 leading from the alternator 18 to a voltage regulator 26. The voltage regulator 26 has second lead wires leading to a battery 27. (see FIG. 4).

An alternative drive means can be found in FIG. 5 wherein there is shown a funnel 13, a fan 14 (in phantom), with vertical vanes 25 (in phantom), with a vertical shaft 15 centered in the fan 14. Also shown is a set of sprockets 31 and a drive chain 32.

This embodiment of the invention operates similarly to the embodiment set forth just above.

### EXAMPLE

Comparison devices were fabricated in a mechanical shop such that a unit was built according to that disclosed in U.S. Pat. No. 11,746,751 to Oroza. The device was built such that the leading edges of the vanes on the fan were less than 1/2 inch from the inside wall of the funnel or housing. The device was mounted on top of a Ford pickup truck on ladder racks such that the funnel was mounted above cab height. In this type of apparatus, driving at 70 miles per hour, there was no air moving through the funnel. Thus, no voltage was generated at all.

The device was re-assembled and modified by moving the vanes away from the interior wall of the funnel(housing) by 1 inch. Driving the vehicle at 70 miles per hour resulted in the movement of air through the funnel and a reading of 220 volts of power was realized.

When the device was again modified so that the leading edge of the vanes was 3 to 4 inches from the interior wall of the funnel, an increase in over 50% of the air passing into the funnel went through and passed the vanes.

A device according to this invention was built such that the leading edges of the vanes were one inch from the interior wall of the funnel. When tested on the vehicle, a voltage of 220 volts was achieved at 70 miles per hour.

What is claimed is:

1. An electric generating assembly, said assembly comprising:
A) an air collection funnel, said funnel having a front end opening and a back end opening, said front end opening being larger in size than said back end opening;
B) a fan, said fan having vertical vanes having leading edges, said fan mounted in a predetermined position in said funnel such that a portion of any air moving through the funnel contacts said vanes and a portion of the air moving through the funnel passes said vanes, said vanes leading edge being one inch or more in distance from the interior wall of the funnel;
C) said fan being mounted on a shaft and said shaft extending below said funnel a predetermined distance, said shaft having a terminal end;
D) an alternator mounted on said terminal end;
E) said alternator being electrically attached to a voltage regulator by electrical wires.

2. The electric generating assembly as claimed in claim 1 wherein said voltage regulator is attached to a battery by electrical wires.

3. An electric generating assembly, said assembly comprising:
A) an air collection funnel, said funnel having a front end opening and a back end opening, said front end opening being larger in size than said back end opening;
B) a fan, said fan having vertical vanes having leading edges, said fan mounted near a middle of said funnel such that a portion of any air moving through the funnel contacts said vanes and a portion of the air moving through the funnel passes said vanes, said vanes leading edge being one inch or more in distance from the interior wall of the funnel;
C) said fan being mounted on a first shaft and said first shaft extending below said funnel a predetermined distance, said first shaft having a terminal end and a first drive means mounted on said terminal end;
D) an alternator mounted separately from said first shaft said alternator having an extended center shaft and said extended center shaft having a second drive means mounted on a terminal end thereof and said first drive means and said second drive means horizontally aligned;
E) a drive mechanism connecting said first drive means and said second drive means;
F) a voltage regulator electrically attached to said alternator by electrical wires.

4. The electric generating assembly as claimed in claim 3 wherein said voltage regulator is electrically attached to a battery by electrical wires.

5. The electric generating assembly as claimed in claim 1 when mounted in a vehicle.

6. The electric generating assembly as claimed in claim 3 when mounted in a vehicle.

7. A method of generating electrical power, said method comprising mounting an electric generating assembly as claimed in claim 1 in a vehicle in a position wherein forced air is provided to said electric generating assembly.

8. A method of generating electrical power, said method comprising mounting an electric generating assembly as claimed in claim 3 in a vehicle in a position wherein forced air is provided to said electric generating assembly.

9. The electric generating assembly as claimed in claim 3 wherein the drive mechanism is a belt and pulley.

10. The electric generating assembly as claimed in claim 3 wherein the drive mechanism is a roller chain and sprocket.
